(19) United States
(12) Patent Application Publication
(10) Pub. No.: US 2017/0107088 A1
(43) Pub. Date: Apr. 20, 2017

(54) Brake System For A Forklift Truck

(71) Applicant: Big Lift, LLC, Lombard, IL (US)

(72) Inventors: Yu Xiaoxian, Hangzhou (CN); Li Yang, Hangzhou (CN)

(21) Appl. No.: 14/976,648

(22) Filed: Dec. 21, 2015

(30) Foreign Application Priority Data
Oct. 20, 2015 (CN) 201520814806.4

(51) Int. Cl. B66F 9/075; B60T 7/06; B60T 7/04; B60T 13/58

(52) U.S. Cl. CPC B66F 9/07509; B60T 13/58; B60T 7/06; B60T 7/042

(57) ABSTRACT

A brake system for a forklift truck includes a double brake mechanism, having a mechanical brake mechanism further including a foot brake pedestal, a foot pedal, a brake pump having a push rod, a rotation shaft connected to the foot brake pedestal, with the foot pedal being connected to the rotation shaft by a link, a connecting seat on the rotation shaft, wherein the connecting seat is connected to an end of the push rod of the brake pump, a compression spring and a spring sleeve are slidably mounted relative to the rotation shaft and configured to compress the compression spring upon rotation of the rotation shaft, and having an electrical brake mechanism further including a micro switch that receives a signal from a foot pedal movement sensor, wherein the micro switch sends a switch signal to a controller that controls a drive motor of the forklift truck.

### CROSS-REFERENCE TO RELATED APPLICATION

This application claims priority to Chinese Patent Application No. 201520814806.4, filed Oct. 20, 2015, which is hereby incorporated by reference in its entirety.

### FIELD OF THE INVENTION

The disclosure relates to forklift trucks, and more particularly to a double brake mechanism used on a forklift truck.

### BACKGROUND

Forklift trucks are industrial vehicles and may be of various wheeled types. Forklift trucks may be used for cargo loading and unloading, stacking and short distance transportation operations. The international standards organization ISO/TC110 refers to them as industrial vehicles, and forklift trucks commonly are used to transport large objects, usually using a motor that includes a fueled engine or a battery drive.

At present, brake mechanisms used on forklift trucks include either a mechanical brake mechanism or an electric brake mechanism, and it is difficult to combine such systems. Actual use of a mechanical brake mechanism in regular situations will cause a certain energy waste, and due to the high frequency of use, there will be a certain impact on the life of the mechanical brake mechanism. Also, for emergency use, sometimes there may not be enough distance to brake if using only an electric brake mechanism, due to its lesser braking effectiveness.

### SUMMARY

The disclosure provides a brake system for a forklift truck that includes a double brake mechanism that overcomes the above problems wherein a single brake system of either the mechanical or electrical type will not provide brake function that is comprehensive enough, and able to be used reasonably in all situations.

In order to solve the technical problems, the brake system of the present disclosure utilizes the following technical scheme. A forklift truck brake system is provided which includes a double brake mechanism. The double brake mechanism comprises a mechanical brake mechanism that includes a foot brake pedestal, a foot pedal and a brake pump, and an electrical brake mechanism that includes a motor to control forklift truck speed, a controller that controls the motor, a sensor to sense the movement of the foot pedal and a micro switch that receives a sensor signal from the sensor and sends a switch signal to the controller to control forklift truck speed.

The mechanical brake mechanism further includes a rotation shaft that is connected to the foot brake pedestal, with the foot pedal being connected to the rotation shaft by a link. The brake pump, or brake master cylinder, includes a push rod and a connecting seat is mounted on the rotation shaft and is connected to an end of the push rod. A compression spring and a spring sleeve are slidably mounted relative to the rotation shaft and resist rotation of the rotation shaft. The double brake mechanism further comprises an electrical brake mechanism that includes a micro switch that transmits a signal based on movement of the foot pedal to control forklift truck speed. The micro switch receives a sensor signal from a sensor that monitors movement of the foot pedal and transmits a switch signal to a controller that controls a motor that controls the forklift truck speed.

In the preferred example, the connecting seat comprises a connecting block fixedly mounted on the rotation shaft, and the rotation shaft may be formed as a cylindrical shaft or tube that rotates on an elongated pin or solid shaft. A U-shaped connecting piece is connected to the connecting block via a pin, with the end of the push rod being connected to a base of the U-shaped connecting piece. The pin connecting the U-shaped connecting piece and the connecting block provides an active connection, so that the link, the rotation shaft and the U-shaped connecting piece form a linkage mechanism which can apply suitable force to the push rod of the brake pump.

The preferred example further includes connection of the push rod and the U-shaped connecting piece via a fastening nut, with a gap between the fastening nut and the spring sleeve, with the spring sleeve and compression spring being slidably mounted on the push rod. The fastening nut may be used to prevent slack within the assembly.

In a preferred example, a reset spring is connected between the foot brake pedestal and the link that is connected to the foot pedal. The reset spring is biased to force the link to reset the system, so that the brake system can continually be ready to operate. The preferred example also includes a baffle on the foot brake pedestal which prevents the spring sleeve from moving in a direction away from or opposite the brake pump.

The disclosure provides an advantageous technical effect by adopting the above technical scheme, wherein the brake system combines a mechanical brake mechanism and an electrical brake mechanism, which together may realize smooth and low noise braking when the motor is used in regular operation, and may realize high efficiency and timely braking in an emergency.

### BRIEF DESCRIPTION OF THE DRAWINGS

FIG. 1 is a side view of a portion of an example brake system of the present disclosure;

FIG. 2 is a top view of the portion of the example brake system shown in FIG. 1; and

FIG. 3 is a further top view including additional components of the example brake system of the present disclosure; and

FIG. 4 is a diagram showing the functional relationship of components within the example brake system of the present disclosure.

The components in the drawings are referred to as follows: foot brake pedestal 1, foot pedal 2, brake pump 3, micro switch 4, reset spring 5, sensor 6, rotation shaft 11, connecting seat 12, baffle 13, linkage 21, push rod 31, compression spring 110, spring sleeve 111, connection block 120, pin 121, U-shaped connecting plate 122, fastening nut 123, motor 130, controller 131, and an accelerator pedal 132. A further detailed description of the drawings and examples is presented below.

### DETAILED DESCRIPTION OF THE PREFERRED EMBODIMENT

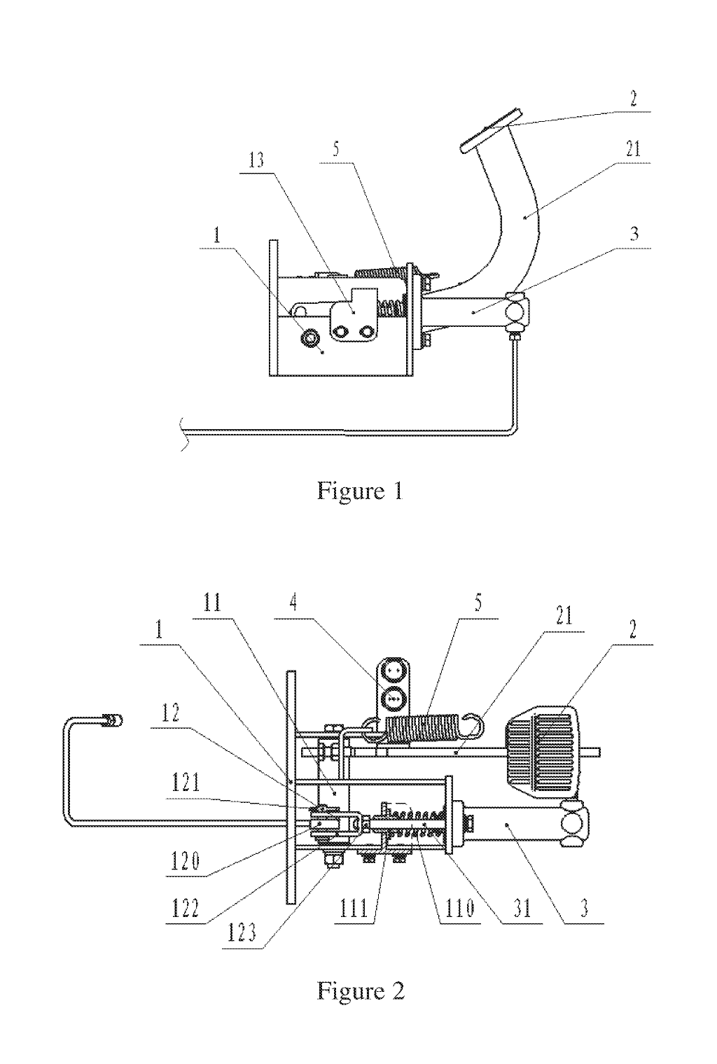

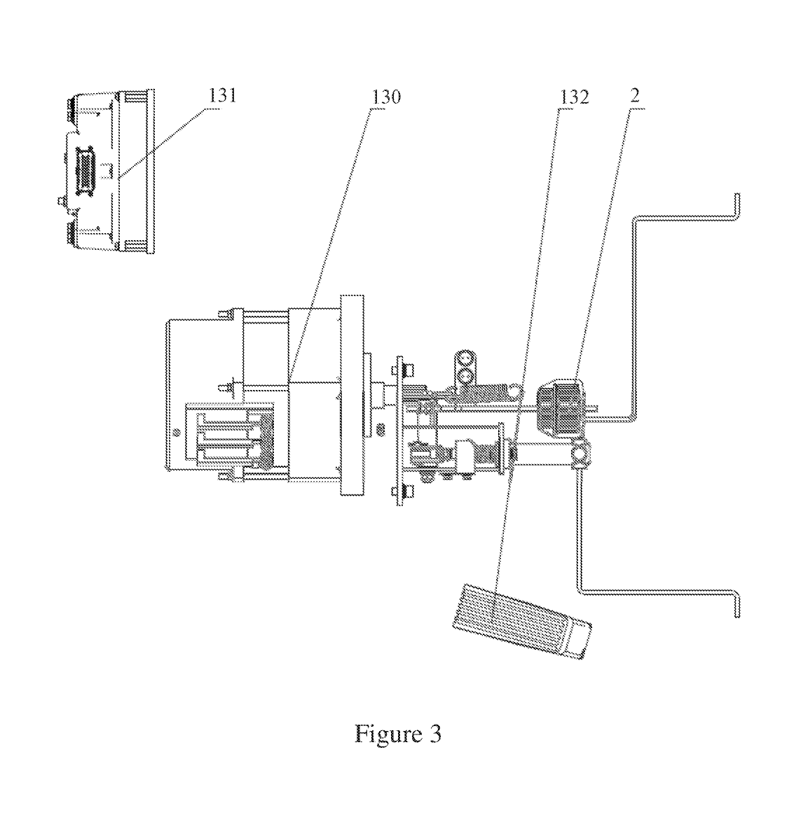

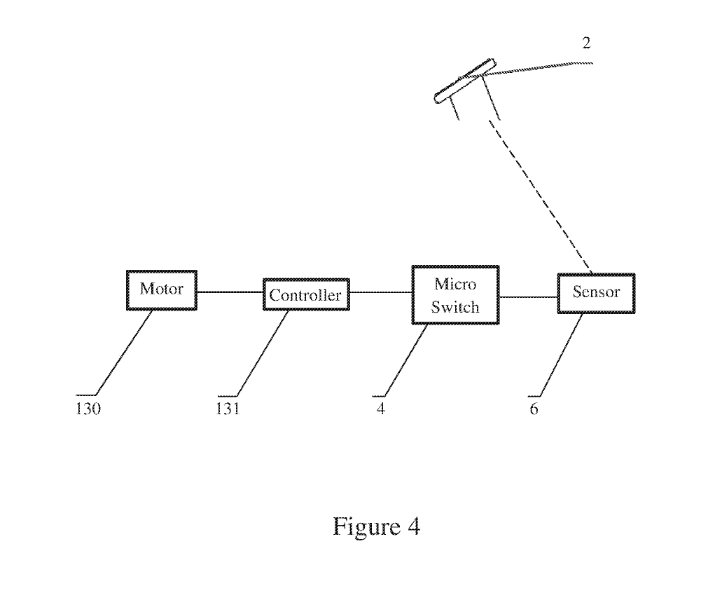

A double brake system for a forklift truck is shown in in various representative FIGS. 1-4. The double brake system is usable on a forklift truck having a motor 130 to control the truck speed, a controller 131 which controls the motor 130, a sensor 6 to sense movement of a brake foot pedal 2 and a micro switch 4 which receives a signal from the sensor 6 and transmits a switch signal to the controller 131. An accelerator pedal 132 also communicates with the controller 131, to provide an input to the motor 130 to drive the forklift truck.

In regular working situations, a foot is placed on the foot pedal 2 to push the link 21 to brake. With the electrical brake mechanism, a sensor 6 on the forklift truck chassis will sense movement of the foot pedal 2, and send a sensor signal to the micro switch 4 on the link 21. The micro switch 4 will send a switch signal to the controller 131, and the controller 131 will cause the motor 130 to reduce its rotational speed, so as to realize and adjust to the first action of stepping on and moving the brake pedal 2. In this situation, where the forklift truck is effectively using an electrical brake mechanism to control the forklift truck speed, the braking distance is long, and would not be suitable for an emergency. But in this situation, the drag torque may drive the induction motor and make the motor speed higher than the synchronous speed, so the motor will store part of the braking energy in the battery, thereby achieving energy savings. Meanwhile, using the motor 130 to brake also has at least the advantages of smooth braking, high efficiency, low noise, and reliable performance. Also in this situation, when pressing the foot pedal 2, the brake system makes the push rod 31 move to the right, as shown in FIGS. 1-3, and due to the gap between the fastening nut 123 and the spring sleeve 111, the connecting seat 12 will not touch the spring sleeve 111 at the beginning of the movement, so there is no compressive force on the compression spring 110. At this initial movement period, the motion of the foot pedal 2 is very small, and the brake pump 3 plays a small role at this stage.

The double brake mechanism also includes a mechanical brake mechanism that includes a foot brake pedestal 1, foot pedal 2, a brake pump 3, a rotation shaft 11 on the foot brake pedestal 1, with foot pedal 2 fixedly connected to the rotation shaft 11 by the link 21. The foot brake pedestal 1 includes a first baseplate, two vertically extending side plates installed on the first base plate, a middle plate between the two side plates, and a second base plate connected to and extending between the two side plates for fixedly mounting the brake pump 3. A connecting seat 12 is connected to the rotation shaft 11 and is connected to the end of the push rod 31, which is part of the brake pump 3. A compression spring 110 and a spring sleeve 111 are slidably mounted on the push rod 31 and relative to the rotation shaft 11, such that the compression spring 110 is compressed when the rotation shaft 11 is rotated. The connecting seat 12 includes a connecting block 120 fixedly mounted on the rotation shaft 11, and a U-shaped connecting piece 122 connected to the connecting block 120 via a pin 121. The end of the push rod 31 is connected to the base of the U-shaped connecting piece 122, wherein the connection of the push rod 31 and U-shaped connecting piece 122 is secured by a fastening nut 123, with a gap between the fastening nut 123 and the spring sleeve 111.

In heavy braking, or in an emergency, a user presses foot pedal 2, moving the link 21 and rotation shaft 11 until the fastening nut 123 contacts the spring sleeve 111. With force applied to the spring sleeve 111, the fastening nut 123 will push the spring sleeve 111, and due to the compression spring 110, the resistance to movement of linkage 21 will provide some resistance or a heavier brake feel. Meanwhile the movement of the linkage will increase and will make the push rod 31 move into the brake pump 3, which will cause the brake pump 3 to work. This work means that the hydraulic brake power from brake pump 3 is transferred to the mechanical brakes of the forklift truck, such as via hydraulic brake fluid lines, to achieve the stopping purpose of the brakes.

There is a reset spring 5, which is connected between the link 21 and the foot brake pedestal 1. The link 21 will be biased by the reset spring 5 toward a reset position, which will keep the brake system continuously ready to work. There also is a baffle 13 on the foot brake pedestal 1 which limits the spring sleeve 111 from moving in a direction away from or opposite the brake pump 3. The baffle 13 is fixed on one of the side plates of the foot brake pedestal 1, and on its bottom, there is a half-round slot which is stuck to one side of the spring sleeve 111, to avoid the spring sleeve 111 moving toward the connecting seat 12, so as to prevent the spring sleeve 111 from coming off of the push rod 31.

The double brake mechanism can realize smooth and low noise braking in regular situations, and high efficiency and timely braking in emergency situations, by combining the mechanical brake mechanism and the electrical brake mechanism, which influences the motor and forklift truck speed. This combined system also will reduce the impact on the mechanical brake life.

It will be understood that the above example presents a preferred embodiment, but the patent is entitled to a range of equivalents and is directed to embodiments that may include modifications, as long as they fall within the coverage of the claims.

1. A brake system for a forklift truck that includes a double brake mechanism comprising:
a mechanical brake mechanism further comprising:
a foot brake pedestal,
a foot pedal,
a brake pump having a push rod,
a rotation shaft connected to the foot brake pedestal,
the foot pedal being connected to the rotation shaft by a link,
a connecting seat on the rotation shaft, wherein the connecting seat is connected to an end of the push rod of the brake pump,
a compression spring and a spring sleeve being slidably mounted relative to the rotation shaft and being configured to compress the compression spring upon rotation of the rotation shaft; and
an electrical brake mechanism further comprising:
a sensor that senses the foot pedal position,
a micro switch that receives a sensor signal from the sensor,
a controller that controls a motor,
wherein the micro switch receives a sensor signal from the sensor and transmits a switch signal to the controller to control the motor speed based on movement of the foot pedal.

2. A brake system for a forklift truck according to claim 1, wherein the connecting seat further comprises a connecting block fixedly connected to the rotation shaft, and a U-shaped connecting piece connected to the connecting block via a pin, wherein the end of the push rod is connected to a base of the U-shaped connecting piece.

3. A brake system for a forklift truck according to claim 2, wherein the connection of the push rod and the U-shaped connecting piece includes a fastening nut, and the compression spring and spring sleeve are slidably mounted on the push rod and there is a gap between the fastening nut and the spring sleeve.

4. A brake system for a forklift truck according to claim 1, wherein a reset spring is connected to the link and the foot brake pedestal.

5. A brake system for a forklift truck according to claim 1, wherein a baffle is connected to the foot brake pedestal and prevents the spring sleeve from moving in a direction away from the brake pump.
